(19) United States
(12) Patent Application Publication
(10) Pub. No.: US 2019/0114699 A1
(43) Pub. Date: Apr. 18, 2019

(54) SYSTEM AND METHOD FOR PRODUCT DESIGN, SIMULATION AND ORDERING

(71) Applicants: Joseph R. Cook, Parkland, FL (US); Kristin E. Cook, Parkland, FL (US)

(72) Inventors: Joseph R. Cook, Parkland, FL (US); Kristin E. Cook, Parkland, FL (US)

(21) Appl. No.: 15/783,920

(22) Filed: Oct. 13, 2017

(51) Int. Cl. G06Q 30/06; G06F 17/50; G06T 11/60

(52) U.S. Cl. CPC G06Q 30/0643; G06F 17/50; G06Q 30/0621; G06T 11/60; H04M 1/72522; G06F 2217/04; G06T 2200/24; G06T 2210/04; G06F 2217/02

(57) ABSTRACT

Disclosed is a system and method for dynamically designing, selecting and purchasing multi-component products, such as consumer or industrial products, or portions thereof. The system and method presents a large universe of available components for multi-component products, and permits consumers to select components for, and ultimately construct, component-by-component, virtual renditions of products, and view real world three-dimensional simulations of the finished products, and allows the rendering of the products in any one of a number of backgrounds, themes, decors, etc. The system may cause the universe of available components to change each time a consumer selects a component. Specifically, as the consumer selects a particular component, any components that are incompatible with the selected component are taken out of the universe of remaining available components. Once the consumer selects all of the components for a given product, and has viewed the finished virtual three-dimensional rendering thereof, the consumer can order the product, or modify the product by deleting and/or adding components from any level of the selection process. The system also allows the design, selection and purchase of single-component products and the rendering of them in any one of a number of backgrounds, themes, decors, etc.

### TECHNICAL FIELD

This disclosure relates to a system and method for designing and viewing a simulation of the design of products that are comprised of a single component or multiple components in any number of possible configurations, themes, decors, etc. More particularly, this disclosure relates to a system and method for systematically, rapidly and dynamically designing and creating a virtual representation of a product using visual tools and simulating a three dimensional, virtual depiction of the product in any number of potential, alternative, in-use environments.

### BACKGROUND OF THE INVENTION

For sellers of products, whether those products that are comprised of a single component or multiple alternative components, parts, features and/or configurations, or which are otherwise customizable, making the process of selecting, designing, and/or purchasing the final product by the user easy and convenient is essential to sales success. However, the user must use his or her imagination when the actual product the user desires is not actually (i.e., partially or totally physically installed) or virtually present in front of the user.

This has especially been the case for website and other electronically accessed sales platforms, such as mobile apps and on-site or wide area network applications. The user looking to purchase a product online or using another type of electronically accessed platform (e.g., on a local or wide area network, a mobile app or the like) that has multiple alternative parts, features and/or configurations would like to see what the final product will look like in any one of a number of potential in-use environments when each of the alternative parts, features and/or configurations are included. Heretofore, most such platforms don't have anywhere near that capability.

For example, designing kitchens, bathrooms, showers, shower enclosures and other aspects of kitchens and bathrooms, (along with any other indoor or outdoor areas), involves much planning and decision making. Between thematic, ergonomic and specific componentry (e.g., appliances, sink, drain placement, plumbing fixtures, colors, tiles, sizes, dimensions, shower doors, shower shelves, wall coverings, floor coverings, cabinetry, plumbing fixtures, shower hardware, accessories, kitchen appliances, kitchen accessories, etc., collectively “product components”) considerations which are taken into account in designing such installations, an endless number of possibilities could be examined.

However, due to the limitations in the number of potential components that can be made available for a user to choose from when combining them into a potential purchasable product or combinations of products in any number of combinations and viewed in any of a number of alternative configurations, backgrounds, themes, decors, etc., to view online or in any other electronic sales platform during the shopping/design process, the entire range of possible features that a purchaser can view and select from is so greatly limited that more sales are lost than are made and results in more dissatisfied customers.

For example, for a consumer who wants to redesign a bathroom, there is an unacceptably limited universe of potential component products available on bathroom products and home improvement websites. This results in some projects being abandoned altogether, as the necessary level of enthusiasm is never generated by what the consumer believes is a limited range of alternatives. Moreover, for many completed projects that include components that are purchased online, the consumer winds up dissatisfied because the end result does not look and/or function in the manner which the consumer imagined it would. However, had the consumer had a more comprehensive universe of available components to pick and choose from, and a means of trying out and actually viewing as many of those available components in a virtual completed project as the consumer wanted to see, the consumer could have created the exact result he or she had hoped for and envisioned.

Presently, however, no online or other electronically accessible tool exists to assist consumers in the design and real-time viewing of products installed in a setting that resembles the consumer's setting such as kitchens, bathrooms and showers and other indoor and outdoor settings.

Computing and three dimensional (3D) modeling systems have been used in a limited capacity for building and/or architectural design. In particular, architects and interior designers (or “designers”) use a wide range of computer-aided design (CAD) software for designing the aesthetic as well as functional aspects of a given residential or commercial space. For example, a designer might use an architectural design program (e.g., a CAD program) to design the interior layout of a bedroom. The designer might then render the layout to create a 3D model of the interior of the bedroom that can be displayed to a client. However, significant training and experience are required to use CAD programs effectively. Thus, currently there are realistically no effective solutions that enable the average consumer to use a computer aided design tool to design single or multi-component products, while visualizing them in any one of a limitless number of architectures, surroundings, themes, decors, etc., and/or to purchase the product so designed.

In bathroom and shower design, there exist very few options for consumer input to a computer aided design system. Moreover, to the extent that some users have training or experience in the use of typical CAD programs, simultaneous knowledge of typical dimensions used in the industry, and dimensions of available products, is limited. Thus, there is no solution available which enables consumers to use a computer-based tool to efficiently and cost effectively design single or multi-component products, including but not limited to kitchens, bathrooms and showers, while being able to perceive limitless visual 3D representations, renderings or virtual walkthroughs thereof.

Moreover, the few tools which do exist use default imaging that is stretched or snapped to a particular dimension, and therefore does not represent the actual products, and their visual representation, available for selection. It should be appreciated that allowing a consumer to incorporate one of more of a variety of components and their actual images when designing a 3D model of a single or multi-component product, presented in varied or alternative architectures, surroundings, configurations, themes, décor, including but not limited to kitchens, bathrooms and showers, and to be able to vary and switch at will between and among alternative architectures, surroundings, themes, components, decors, etc., will result in a more visually appealing model, and improve efficiency in product selection, design and purchase, while more accurately reflecting a real-world model of what the product would look like in use.

Accordingly, an advantage in the art can be realized with systems, methods and computer program products that are easy to use and do not require training and experience, allow for designing first using available product selections and dimensions, and, optionally, creating customized products as desired, while providing a real world visual representation, visualization or simulation of the product for more effective and efficient product selection to better match consumer expectations with the real-world completed design.

### SUMMARY

Embodiments described herein relate to a system and method for presenting to consumers a large universe of available products and/or components for multi-component products, and for permitting consumers to select products and components for and ultimately construct, component-by-component, virtual renditions of products, and view real world 3D simulations of the finished products. The system causes the universe of available components to change each time a consumer selects a component. The rendition of the product changes in real time each time the selection of a component, architecture, surrounding, theme, layout, location, décor, placement, configuration, environment, etc. is made.

For example, in the case of a multi-component product, as the consumer selects a particular component, any components that are incompatible with the selected component are taken out of the universe of remaining available components, and the rendition displayed to the consumer of the product (or portion of the product being created) is updated. Once the consumer selects all of the components for a given product, and has viewed the finished virtual 3D rendering thereof, the consumer can order the product, or modify the product by deleting and/or adding components from any level of the selection process.

In one implementation of the invention, the system is an online, image-based, virtual design, selection and shopping/purchasing experience that permits consumers to easily peruse choices of single-component products.

In another implementation of the invention, the system is an online, image-based, virtual design, selection and shopping/purchasing experience that permits consumers to easily peruse choices of components of multi-component products. In another implementation of the invention, the resulting product is a finished bathroom or shower. A webpage or other graphical user interface (collectively hereinafter “GUI” or “webpage”) is made available for access by consumers, who are sometimes referred to herein as “users.” A plurality of base image choices are presented on the GUI. A base image may be a depiction of an environment for the product, such as a graphical representation of a bathroom. The base images represent the basic architecture of a bathroom, into which the components of a shower can be installed, component by component, by the user. The base images may include, but need not necessarily include, and are not limited to, a variety of different themes or decors, a variety of different background features, and a variety of architectural configurations. The base images may also include one or more blank areas into which the user may cause the system to populate one or more products or product components. For example, the one or more blank areas may be where a shower or portion of a shower is to be placed, or where one or more cabinets, doors, screens, niches, bathtubs, etc. may be placed by the user using the system.

Once a particular base image is selected, the user is prompted to begin the process of selecting and/or modifying parameters for the finished bathroom or shower product, such as one or more of the following, by way of example and not limitation: dimensions, drain position, curb style, drain grate style, curb width, benches, niches, doors, glass panels, hardware, vanities, fixtures, wall and floor coverings and accessories.

The user can begin the component selection process at any level. For example, in an embodiment, the user selects a base image, then can first select a drain location, then a type of drain, then the type of shower pan, then the dimensions of the shower pan.

Alternatively, in another embodiment, the user can select the pan type, then select the pan dimensions, then the drain location, then the drain type, and so forth.

Alternatively, in still another embodiment, the user can select shower doors, shower screens, shower hardware, décor, or any other things that may be selected for inclusion in a bathroom product.

In other embodiments, as will be discussed more fully hereinafter, the user can change the theme or décor of the base image at any stage in the process of selecting components or features/attributes of components.

In an embodiment, a matrix is populated with all of the possible environments, backgrounds, architectures, configurations, themes and/or decors, and the same or one or more other matrices are populated with the components available for the user to incorporate into a product to be virtually built by the user.

In another implementation of the invention, the resulting product is a finished kitchen. A webpage is made available for access by consumers. A plurality of base image choices is presented on the webpage. A base image may be a depiction of an environment for the product, such as a graphical representation of a kitchen. The base images represent the basic architecture of a kitchen, into which the components of a kitchen can be installed, component by component, by the user. The base images may include, but are not limited to, a variety of different backgrounds, themes or decors, and a variety of architectural configurations. The base images may also include one or more blank areas into which the user may cause the system to populate one or more products or product components. For example, the one or more blank areas may be where an appliance or portion of an appliance is to be placed, or where one or more cabinets, countertop(s), doors, niches, furniture, wall and/or floor coverings, accessories, lighting, etc. may be placed by a user using the system.

Once a particular base image is selected, the user is prompted to begin the process of selecting and/or modifying parameters for the kitchen or kitchen product, such as dimensions, appliance position(s), cabinet style, appliance brands, counter tops, wall and/or floor coverings, accessories, lighting, etc.

The user can begin the component selection process at any level. For example, in an embodiment, the user selects a base image, then can first select a sink or other fixture or appliance location, then cabinets, then the type of counter top, then the dimensions of the cabinets and/or counters, etc.

Alternatively, in another embodiment, the user can select the room dimensions, then the location of windows, doors, etc., then select the appliance type/style/color/finish, etc., then the counters, then cabinets, then accessories, lighting, furniture, etc., and so forth.

In embodiments, as will be discussed more fully hereinafter, the user can change the architecture, configuration, theme and/or décor of the base image at any stage in the process of selecting components or features/attributes of components.

In embodiments, a matrix is populated with all of the possible environments, themes, decors, architectures and/or configurations, and the same or one or more other matrices are populated with the components available for the user to incorporate into a product to be virtually built by the user and any indoor or outdoor environment.

In some embodiments, the base image, depicting the environment and/or architecture, is displayed in a first visual representation area (for example in a first area of the display screen), and the various component part or other product options/offerings for the user to choose from (or links to open images thereof) are displayed in the first visual representation area or in one or more additional separate visual representation areas (for example in a second area of the display screen, or in second, third, etc. display areas) on the same page. As the user makes his or her selection(s) from among the available component parts and/or products, the base image appearing in the first visual representation area is updated, augmented and/or modified with the component part selection(s) to create a visual representation of the product being virtually assembled.

The term “updated” as it pertains to the first visual representation area refers to the change and/or alteration of the visual display in the first visual representation area. At one or more points during the selection process, the base image is modified to incorporate the different selection(s) made by the user. In at least one embodiment, the base image is not updated until the user makes the final selection and/or instructs the system to update the image.

In embodiments where one or more blank spaces are included in the base images, as the user makes his or her selection(s) from among the available component parts and/or products, the base image appearing in the first visual representation area is updated, augmented and/or modified with the component part selection(s) being reproduced in the one or more blank areas to create a visual representation of the product being virtually assembled.

In other embodiments, the base image, depicting the environment, is displayed in a first visual representation area (for example in a first area of the display screen), and the various product and/or component part options/offerings for the user to choose from (or links to open images thereof) are displayed in one or more visual representation areas (for example in a second area of the display screen, or in second, third, etc. display areas) on one or more different pages. As the user makes his or her selection(s) from among the available products and/or component parts, the available products and/or component parts are displayed on a separate page, and, once the additional product(s) and/or component part(s) are selected, the base image appearing in the first visual representation area is updated, augmented and/or modified with the products and/or component part selection(s) to create a visual representation of the product being virtually assembled.

In embodiments, a system of the invention permits a user to shop for a product or products, to select the environment and/or background in which the product or products will be depicted and/or rendered, and to also pick from any number of alternative architectures, configurations, themes, decors, lighting, or other characteristics in which said environment and/or background can be displayed, which permits for the user to best visualize the in-use appearance of the product or products. Doing so offers the user a far more robust shopping experience, one which heretofore has never existed. Allowing the user the opportunity to customize the environment and/or background in which the product or products will be used or installed permits the consumer to have an experience that most closely resembles the actual experience the user will have after the product is purchased.

In yet another embodiment, a system of the invention permits a user to design and build a virtual product from a myriad of component styles and parts, and to render an image of the product as it is being built in the environment and or background selected by the consumer.

Further, the user can change among environments or backgrounds during the process as often as desired.

Further, the system can be used to shop for single or multi-component products while selectively rendering such products in a variety of alternative backgrounds or environments.

The terms “updated,” “augmented” and “modified” refer to the change and/or alteration of the visual display in a visual representation area, and may be used interchangeably. At one or more points during the selection process, the base image may be simultaneously or at a later time modified to incorporate the different selection(s) made by the user. In at least one embodiment, the base image is not updated until the user makes the final selection and/or instructs the system to update the image.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 illustrates a block flow diagram of an embodiment of the inventive method illustrating user inputs.

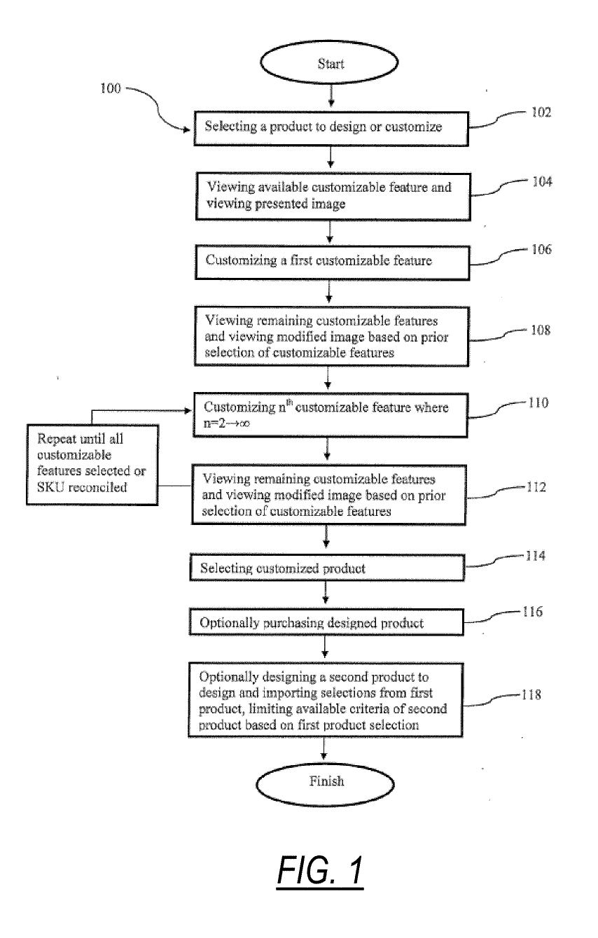

FIG. 2 illustrates a block flow diagram of an embodiment of the inventive method illustrating responses by the method and system based on the user inputs.

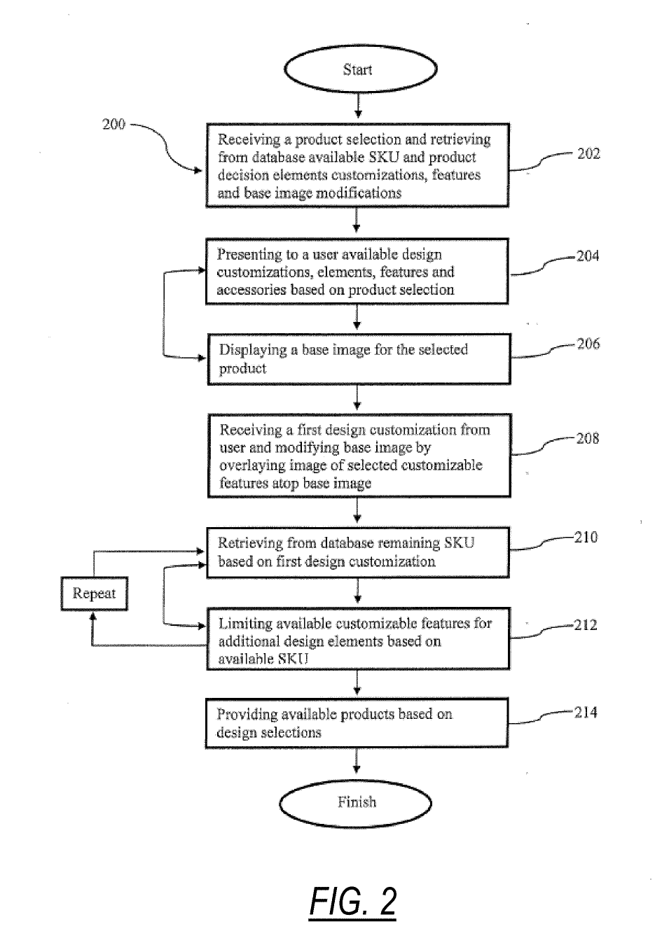

FIG. 3A shows a first wire frame of a sequence of an embodiment of the computer implemented method of the invention.

FIG. 3B shows a second wire frame of a sequence of an embodiment of the invention.

FIG. 3C shows a third wire frame of a sequence of an embodiment of the invention.

FIG. 3D shows a fourth wire frame of a sequence of an embodiment of the invention.

FIG. 3E shows a fifth wire frame of a sequence of an embodiment of the invention.

FIG. 3F shows a sixth wire frame of a sequence of an embodiment of the invention.

FIG. 3G shows a seventh wire frame of a sequence of an embodiment of the invention.

FIG. 3H shows an eighth wire frame of a sequence of an embodiment of the invention.

FIG. 3I shows a second wire frame of a sequence of an embodiment of the invention.

Similar reference numerals refer to similar parts throughout the several views of the drawings.

### DETAILED DESCRIPTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

It should be understood by those of skill in the art that flowcharts and block diagrams herein described may illustrate architecture, algorithms, functionality and operation of possible implementations of systems, methods and computer program products according to various embodiments. Therefore, it should be understood that each block in the flowchart or block diagram may represent a module, segment or portion of code, which comprises one or more executable computer program instructions for implementing the specified logical function or functions. One or more of the blocks can be changed, deleted, or the order of their presentation or use can be changed to any other order. Further, some implementations may include the functions in the blocks occurring out of the order as herein presented, or not in order of execution when a user operates the system. By way of non-limiting example, two blocks shown in succession may be executed substantially concurrently, or the blocks may at times be executed in the order shown or the reverse order, depending upon the functionality involved. It will also be noted that each block of the block diagrams and flowcharts, and combinations of blocks in the block diagram and flowcharts, may be implemented by special purpose hardware-based systems that perform the specified functions or acts, or combinations of special purpose hardware and computer program instructions.

Various terms used throughout the specification and claims are defined as set forth below as it may be helpful to an understanding of the invention.

As used herein a “computing device” shall be a desktop computer, a laptop computer, a dedicated server or server network, a personal digital assistant, a cellular telephone, a set-top box, a music player, a web pad, a tablet computer system, a game console, an electronic book reader, a smartphone, or other type of device with like capability. At a minimum, a computing device has at least one of an identification number, a data storage system, an operating system, a central processing unit (CPU), and an input-output (I/O) system capable of communicating to the network.

As used herein “user” shall mean any prospective or actual shopper for a product that the systems and methods disclosed herein are capable of designing, ordering, creating or purchasing. For example, a user can be a buyer of retail products, a wholesale business, a manufacturer, or any party looking to buy a component product. The terms “consumer” and “user” are used interchangeably in this disclosure.

As used herein a “network” shall be the Internet, intranets, extranets, wide area networks (WANs), local area networks (LANs), wired networks, wireless networks, or other suitable networks, or any combination thereof.

As used herein a “product” [the ultimate thing being created through the process of selection, design and/or purchase as described herein] may be any article, tangible personal property (such as furniture, equipment, room, fixture, appliance, plumbing device, accessory of any type, any combination of products or components in any configuration, environment, theme, décor, etc.) or other thing that is manufactured for retail, wholesale, industrial or any other sale or disposition.

As used herein a “server” may be a server computer or any other system providing computing capability. Alternatively, a plurality of servers may be employed that are arranged, for example, in one or more server banks or computer banks or other arrangements. A server may otherwise be a cloud computing resource, a grid computing resource, and/or any other distributed computing arrangement. Such servers may be located in a single installation or may be distributed among many different geographical locations. For purposes of convenience, “server” is referred to herein in the singular. Even though the server is referred to in the singular, it is understood that a plurality of servers may be employed in the various arrangements as described herein.

As used herein “software” shall mean any machine code, source code, object code, software module or modules, application programming interface or interfaces, executables or other “software” known in the art or in any appropriate computer language.

As used herein a “central processing unit” or “processor” may represent multiple processors, and each “memory” or “data storage system” may represent multiple memories which operate in parallel processing circuits, respectively. The method and system includes one or more processing devices, which may be any computer processing unit, and could be a single central processing unit, or a number of processing units configured to operate either in sequence or in parallel. The processing device can be configured to execute software processes which implement the steps disclosed herein. The system and method may also include a memory capable of storing the instructions necessary for a processing device to implement the steps disclosed herein. This memory could be in the form of memory resident within the processing device or in the form of standalone memory coupled to the processing unit via a communication path, such as a bus or a network.

The systems and methods disclosed herein provide a computer-implemented process for designing and virtually assembling products that are comprised of multiple components. In embodiments, the designing process includes receiving comprehensive information about specific product(s), product components and accessories based on a user's input, and displaying the products based on the user's selections. In embodiments, the designing process includes receiving component choices for inclusion in one or more specific multi-component product(s), and, based on a user's input, displaying the one or more component choices and/or products based on the user's selections.

A dynamic, customizable library system, which may be searchable, is used to store and provide product information, and base images therewith, for products, components and accessories. Upon or after commencement of the design, selection and/or purchase of a product, component or accessory, a base image is presented, which is then updated, augmented or modified by the over layering of additional component image layers, superimposing of additional component images, addition of component images, creation of new images, or any other means for updating, augmenting or modifying the image based on the user's selections and choices in the design process. The inventive systems and methods allow for a user-friendly experience for selecting products, and/or designing products, and/or, optionally, customizing products as desired, and/or purchasing products, while providing a real world, real-time visual representation and interaction with the resulting product for a more effective and efficient product selection experience in which a real-world completed product is displayed in an attractive environment.

Systems and methods of this invention can be implemented using one or more customizable library systems, which allow the customization of the presentation by, for example, changing the sequencing of the presentation of the design, selection or purchase of components or the products, or the experience, enlarging or reducing the number of products or components of products to be displayed, all to suit particular customers or circumstances. Thus, a system can be devised in accordance with one or more principles of the invention which enables a provider of products to tailor and customize the experience for consumers, buyers, wholesalers, distributors, online retailers, brick and mortar retailers, as required by the exigencies of the market or the needs of the provider, at any particular time or place.

### Systems

In one embodiment, there is disclosed a system for dynamically designing products that are comprised of multiple components. In this particular embodiment, but not by way of limitation, the system at least includes a computing device running custom software for designing products that are comprised of multiple components. The custom software furthermore interacts with at least one database. The at least one database contains information related to available products and the components thereof, base images for available product environments and/or backgrounds, complete standalone images and/or images compiled through image layering or any other technology for manipulating or otherwise updating, augmenting or modifying images to depict available product components, selectable or modifiable optional criteria and subcomponents for available products, and design selections for the modifiable optional criteria and subcomponents. Various product information and data may be stored in the database. The database may be representative of a plurality of databases as can be appreciated. In some embodiments, the database or library includes information, by way of example but not limitation, related to products, optional components and accessories, such as one or more of manufacturer name, dimensions, material, finish, color, images, base images, component location information, etc., for product component images, standalone product images, specification of products, components or accessories, costs, stock keeping unit numbers (sku's), etc., or combinations thereof.

At least one embodiment of the custom software, or as may otherwise be herein described, provides a base image representing the base architecture or configuration of an environment or background in which the product will be used, installed or otherwise employed. At least another embodiment of the custom software, or as may otherwise be herein described, provides a base image representing the base architecture or configuration of an environment in which the product will be depicted.

In an embodiment, upon selection of one of the available base images, and selection of one of the available themes or decors for the environment or background in which the multi-component product will be depicted, at least two of the components of the multi-component product to be designed are selected, and as a result of which the software either selects an image that depicts the combined products in the environment and/or combines the image(s) of the product components with the base image of the environment or background to provide a visual representation of the product at a partial or completed stage of design in the environment or background of the user's choosing. The visual representation created by such images may be created by substituting one image for another image, and/or over layering of the image layers for available product components with a base image, or any other means of combining or representing the component images, thereby providing a dramatic visual experience to assist the user in their design, selection, shopping, and/or purchasing process.

In another embodiment, upon selection of one of the available base images, and selection of one of the available themes or decors for the environment or background in which the multi-component product will be depicted, at least two of the components of the multi-component product to be designed are selected, as a result of which the software superimposes one or more additional component images on the original image layer to provide a visual representation of the product at a partial or completed stage of design. The visual representation created by such superimposing provides a dramatic visual experience to assist the user in his/her design, selection, shopping, and/or purchasing process.

In another embodiment, upon selection of one of the available base images, and selection of one of the available themes or decors for the environment in which the multi-component product will be depicted, at least two of the components of the multi-component product to be designed are selected by the user, as a result of which the software creates a new image which includes any additional components selected by the to provide a visual representation of the product at a partial or completed stage of design. The visual representation created by such image creation provides a dramatic visual experience to assist the user in his/her shopping process.

Optionally, the visual representation is representative of a custom product to be fabricated based on the selections of the background or environment/base layer and optional components.

In embodiments, the system can be an isolated, self-contained computing device all inclusive of the database and custom software, one or more input devices such as one or more keyboards, one or more graphical user interfaces, one or more microphones, or the like, and one or more displays.

Alternatively, the system can be comprised of a distributed computing device/system that is remotely running software, from a remote location, or through executable functions within a browser running a web application.

Still alternatively, the system can be comprised of any combination of an isolated, self-contained computing device all inclusive of the database and custom software, one or more graphical user interfaces, one or more input devices such as one or more keyboards, one or more microphones, or the like, and one or more displays, on the one hand, and a distributed computing device/system that is remotely running software, from a remote location, or through executable functions within a browser running a web application

In at least one embodiment, the system further includes a communication network having at least one of a cellular data network and a Wi-Fi network, wherein said computing device and said software are in communication with at least one server using the communication network. In at least one embodiment, the server contains the database of product, theme and decor information, including modifiable components or accessories.

In systems utilizing a server, the server executes one or more SQL queries to find matching product components stored within the database on the server, and returns results to the system's software to be displayed on the display associated with the computing device running the system's software. In some embodiments, the server is further used to store certain profile information for one or more users. The profile information may include the user's name, business name and address, project name, customer name, a database location for storing the designed products by the user, payment information, contact information, and/or previous designs or purchases. In at least one embodiment, users have the ability to store or share product designs such that one or more users may access certain product designs that have been saved by a user.

Various other applications and/or other functionality may be executed on the server according to various embodiments.

Custom Software/Product Design Method

In an embodiment, the software for designing products, whether single component products or products that are comprised of multiple components or accessories, may include instructions, protocols and/or subroutines to interpret commands from a user's input, to process corresponding data, and to run the essential executable code or commands therewith. The software also provides at least one interactive graphical user interface driver for the selection and display of various images chosen. A user may interact with the graphical user interface in any manner, such as with touch commands, with a mouse, a keyboard, with voice commands, or any other controller. The software allows a user to design and/or customize products based on modifiable features representing available products or components of products, or to create custom products to be fabricated for the user upon completion of the design. The software is provided to enable a user to select search parameters, and sends user parameters to a central processing unit, a database, or a server.

In at least one embodiment, two or more separate visual representation areas are incorporated into the display(s) associated with the system. A first visual representation area permits the display of the base image. A second (and optionally third or more) visual representation area permits visual display of one or more available selectable components of a product being designed for the user to choose from. The various available selectable components may be displayed in either a two-dimensional visualization, where each alternative selection is in a simplified form such a line-art drawing (e.g., wireframe), or the like. Or, in the alternative, the selectable components may be displayed in a more complex format, such as a three-dimensional graphical representation, or the like. Each visual representation area may function as a graphical user interface to allow for the user to interact with touch commands, with a mouse, with voice commands, with a keyboard or any other controller.

In at least one embodiment, the user interface of the software includes search tools to enable a user to select preferences, search criteria, or review information related to products, components or accessories. For designing products, the software first provides a user an option for the selection of at least one product to design or to render in any one or more particular architectures, backgrounds, configurations, themes, decors, etc. Upon the selection of: (1) a product type to be designed and/or rendered; (2) a base image embodying a depiction of an architectural environment, background and/or configuration; and (3) a theme or décor for the environment, background and/or configuration, the graphical user interface displays a page containing the first visual representation area in which the base layer is displayed, depicting an architectural environment or background in which the virtual depiction of the product to be ordered will be rendered, displayed, incorporated or installed. In embodiments in which multi-component products are being designed, at least a second visual representation area adapted to depict one or more components of the product is displayed, and the user prompted to select from one or more choices, sequentially, until the user has added all of the components and/or features to the product that the user wishes to have embodied in the actual product to be viewed and/or ordered.

In embodiments, a list of optional criteria for the product is then presented which includes modifiable or customizable options for the product, available components, or available accessories. Without any constraints to a particular selection order, each optional criteria is linked to a base image or portion of a base image which is then updated and/or augmented by the over layering of additional component image layers, superimposing of additional component images, addition of component images, or creation of new images, to provide a visual representation of the design modification or addition made by the selection of the optional criteria.

In at least one embodiment, the universe or inventory of remaining optional criteria is adjusted based on the first optional criterion selected. In at least one embodiment, the optional criteria may be adjusted and/or customized in any order as may be desired by a user, and it should be appreciated that, in doing so, a different design experience, and available choices therewith, is dependent upon the order in which the optional criteria is adjusted.

In at least one embodiment, the universe or inventory of remaining optional criteria is adjusted based on the first optional criterion selected. In at least one embodiment, the universe or inventory of remaining optional criteria may be adjusted and/or customized in any order as may be desired by a user, and it should be appreciated that, in doing so, a different design experience, and available choices therewith, is dependent upon the order in which the optional criteria is selected. In embodiments utilizing two separate visual representation areas, the visual representation of the optional criteria is depicted in an independent representation area that is separate from the representation area in which the base image is depicted. By displaying the base image in separate representation area from the optional criteria, the user is able to visualize the possible variations prior to the variations being incorporated into the base image and/or design of the product.

It is to be appreciated that the representation areas may each be a separate graphical user interface from the other representation areas, rendered on the same screen or additional screens to the screen on which the first representation area appears.

In at least one embodiment, the base image is automatically updated between each selection of optional criteria. In other embodiments, the base image is not updated until the final selection is made. In other embodiments, the user may be able to decide at different points in the selection process whether or not to incorporate the chosen optional criteria into the base image.

In at least one embodiment, the optional criteria depicted within the independent visual depiction area is modified between selections in order to display the subsequent optional criteria for the user to select from.

### Example 1

The systems and methods of the invention have useful application to the design and ordering of household goods, such as kitchen and bathrooms, kitchen and bathroom fixtures, appliances and other constructs, including partial and entire decorated rooms and other living spaces, as well as any indoor or outdoor environments.

In one embodiment, the system is a one-page, image-based, virtual selection, design, shopping, and/or purchasing experience that easily guides users through the choices of bathroom shower base and floor systems, enclosures, upgrades, add-ons and accessories for both inventoried and custom products. The innovative dynamic experience of this embodiment is easy and fun, and users may use the system to visually see their complete shower fully installed in a bathroom with the user's choice of décor, architectural layout, theme, etc. While the description in this example starts with the selection of a shower base, the dynamic design of the system and method allows a user to start at any point (i.e., point 1, point 2, point 3, etc.) in the process and have each of their choices and dimensions carry forward to any subsequent product category they wish to shop within.

In this example, the design employs images to support the visual experience. A “base image” is used, which is the basic architecture of a bathroom. The system, in a preferred embodiment, presents the user with an assortment of varied base bathroom configurations and/or backgrounds to choose from an among. In embodiments, the user can switch between the varied configurations and/or backgrounds at any time during the design, selection and purchasing process. The assortment of available base bathroom configurations and/or backgrounds from which the user may choose can be as varied as the imagination. Any basic room shape and size is contemplated. The configurations and/or backgrounds offered to the user from which to choose may accommodate all possible types and configurations of the planned bathroom and/or shower product configurations. Each of the exemplary customer choices listed below is supported by an image or image layer that is stacked on top of, or otherwise combined with or added to, the base layer to create the shower design a user desires. For example, when choosing a shower drain position, there are images in the database from which the user may choose that include a shower pan floor to selectively fit any possible architecture, regardless of whether the user selects a drain located in either the right, left, center, back or any other location on the shower base.

The addition of a feature, part or accessory to, or the modification of, the base image/environment/background is referred to herein as the selection or designation of an “optional criteria.” Any number of optional criteria may be made available by the system, and different sets of optional criteria may be created and offered in any given setting. For example, a supplier of a particular product may tailor a private label product offering using the teachings of this invention by limiting the universe of optional criteria from that offered by the supplier under the supplier's own brand, and vice versa.

In embodiments, the selection of an optional criteria changes the universe of remaining optional criteria to eliminate from said universe those features, parts or accessories that are incompatible with the base image or optional criteria already chosen by the user or the system.

In another example, the design employs images to support the visual experience. A “base image” is used, which is the basic architecture of a shower within a bathroom, for all possible configurations of the existing and planned shower base product configurations. Each of the exemplary customer choices is supported by an image that is incorporated into, e.g., added to, rendered in a new image with, or otherwise combined with, the base layer to create the shower design a user desires. For example, when choosing a shower drain position, there are images in the database from which the customer may choose that include the shower pan floor to selectively fit each of the architectures having a drain located in either the right, left, center, back or any other location on the shower base.

In some embodiments, the base image incorporates one or more blank spaces where optional criteria, i.e., features, parts or accessories, can be added to the product being designed. The system combines the features, parts or accessories with the base image as optional criteria are selected by the user in such a way that the user builds the product part-by-part, accessory-by-accessory and feature-by-feature by filling in or populating the blank spaces with the features, parts or accessories selected by the user.

In embodiments, programming rules focus on allowing for options based on product attributes that will drill down to an existing inventory SKU; however, where custom product manufacturing is available, the customer is notified of such and may select custom options. In one embodiment, the program code may cause inventory options to be defaulted to standard, stocked, inventory components in order to encourage customers in that direction, while in another embodiment to be defaulted to customized options to encourage customers to view, design, select and/or purchase custom products. The customer may also be informed optionally of any difference in pricing between custom products and inventory products for a more informed design, selection, shopping and/or purchasing experience. Optionally, the program steps may simply allow the customer to direct the ordering process as the customer sees fit. If, for example, a customer chooses a particular shower pan configuration, for example with a right drain, in the first alternative pathway referenced above, there is only one choice available and customers will not see other incompatible component options listed (meaning options that do not accommodate, contemplate or incorporate a right drain); however, the system may be set up such that, if the consumer desires, he or she can choose a “custom” option and choose from other component options.

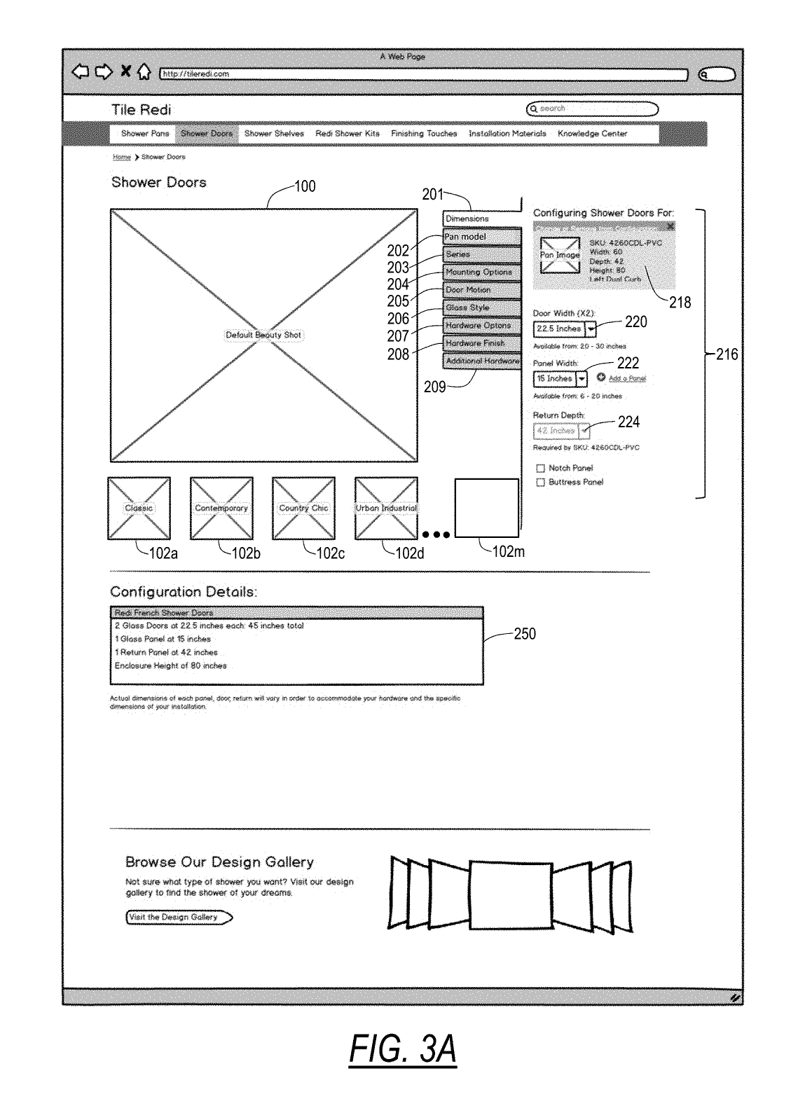

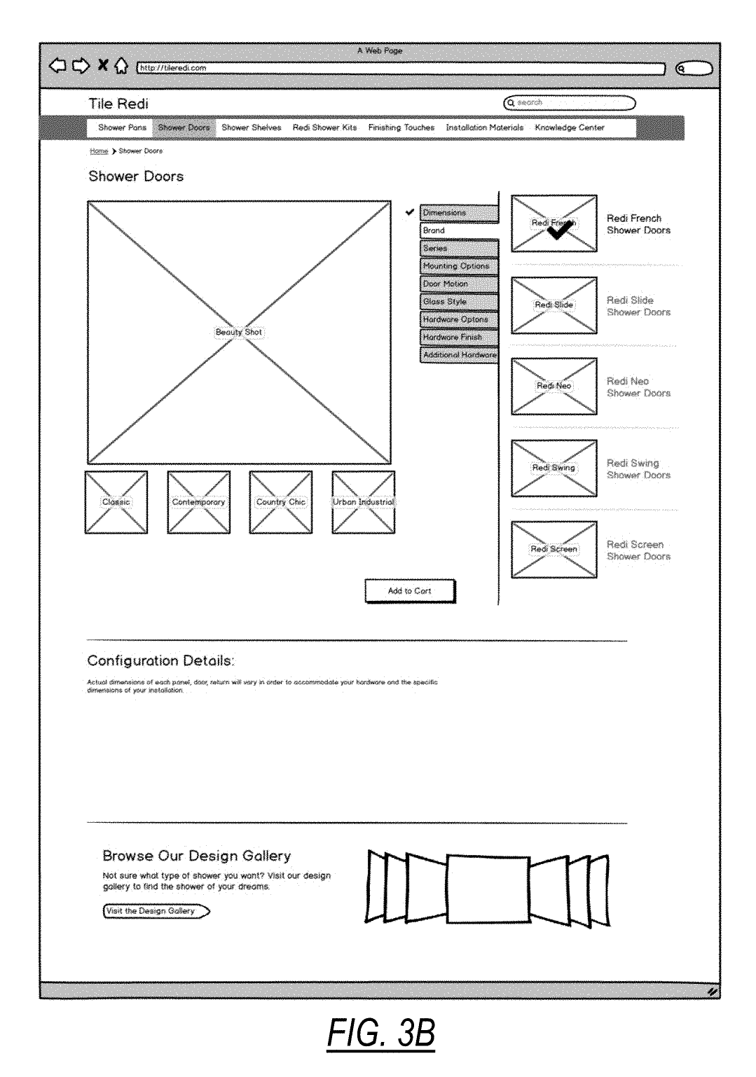

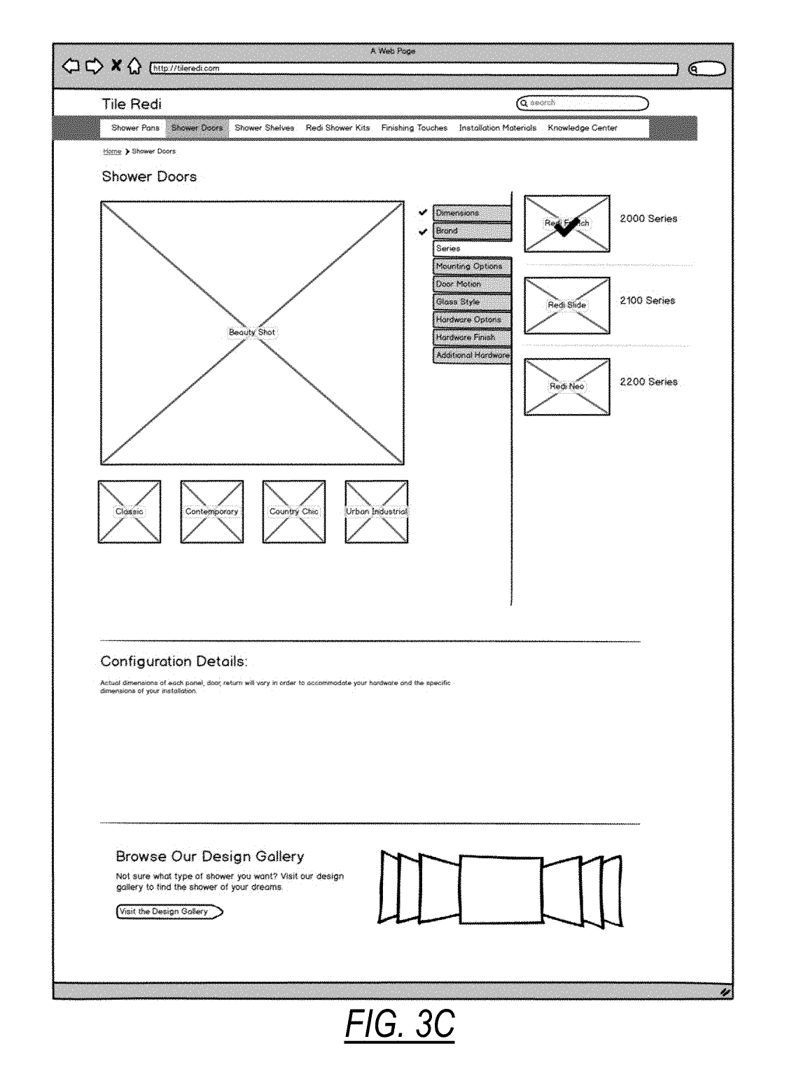

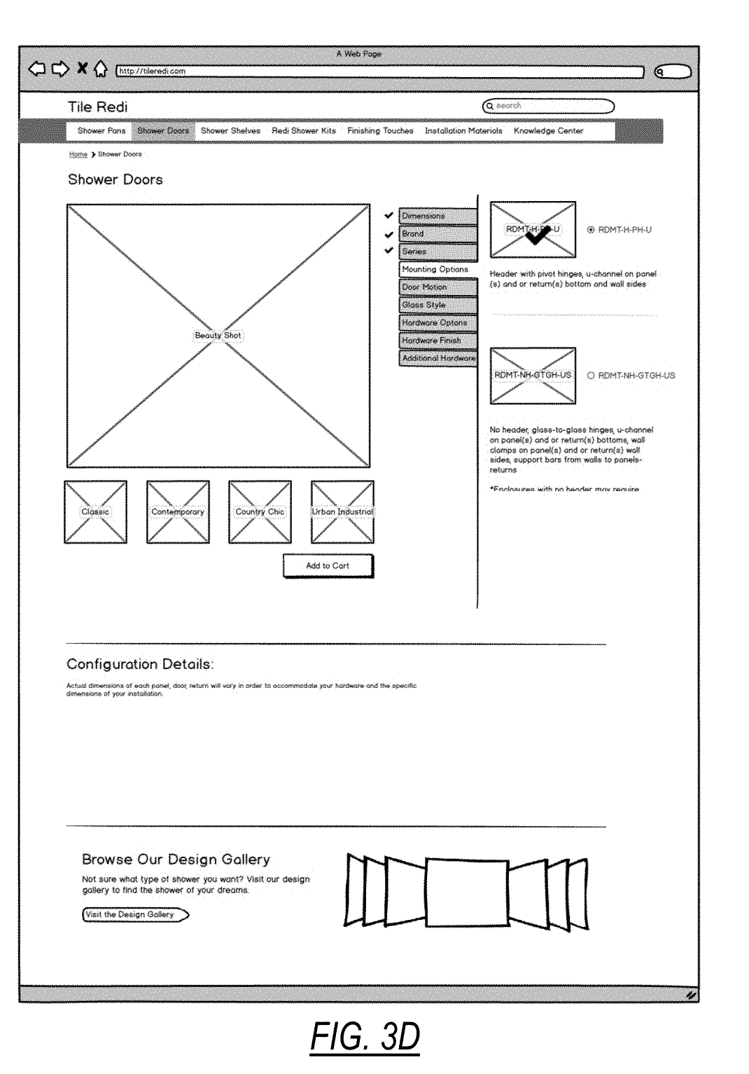

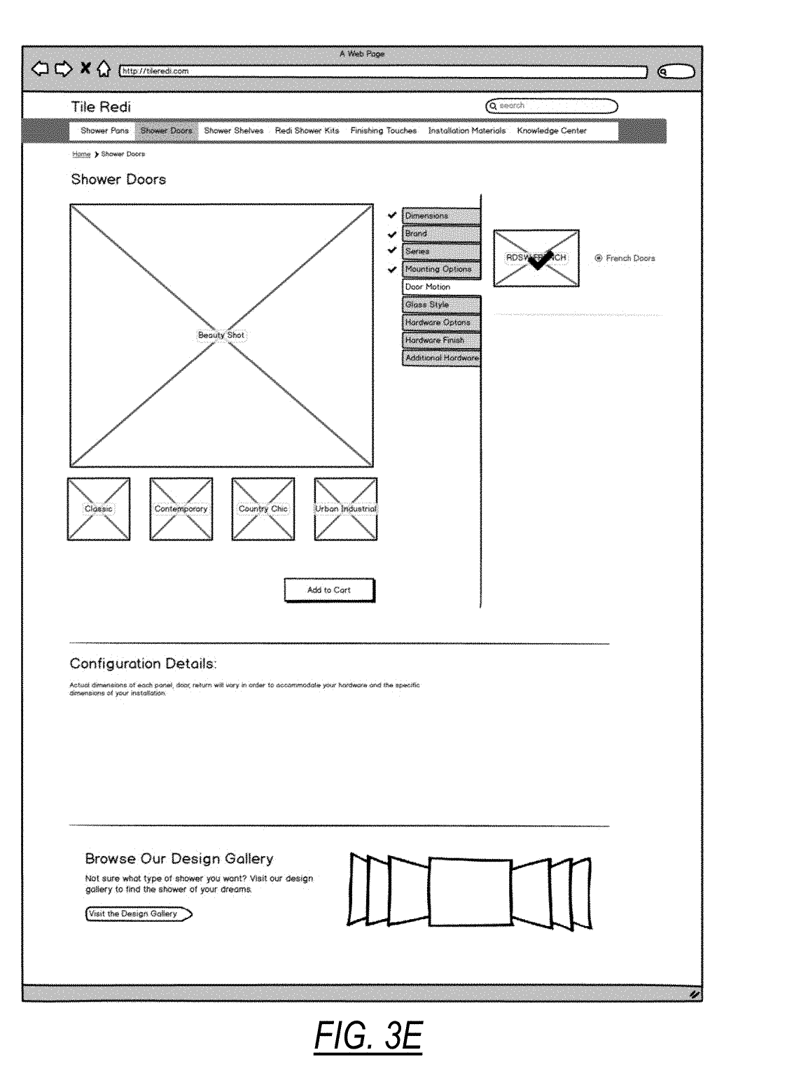

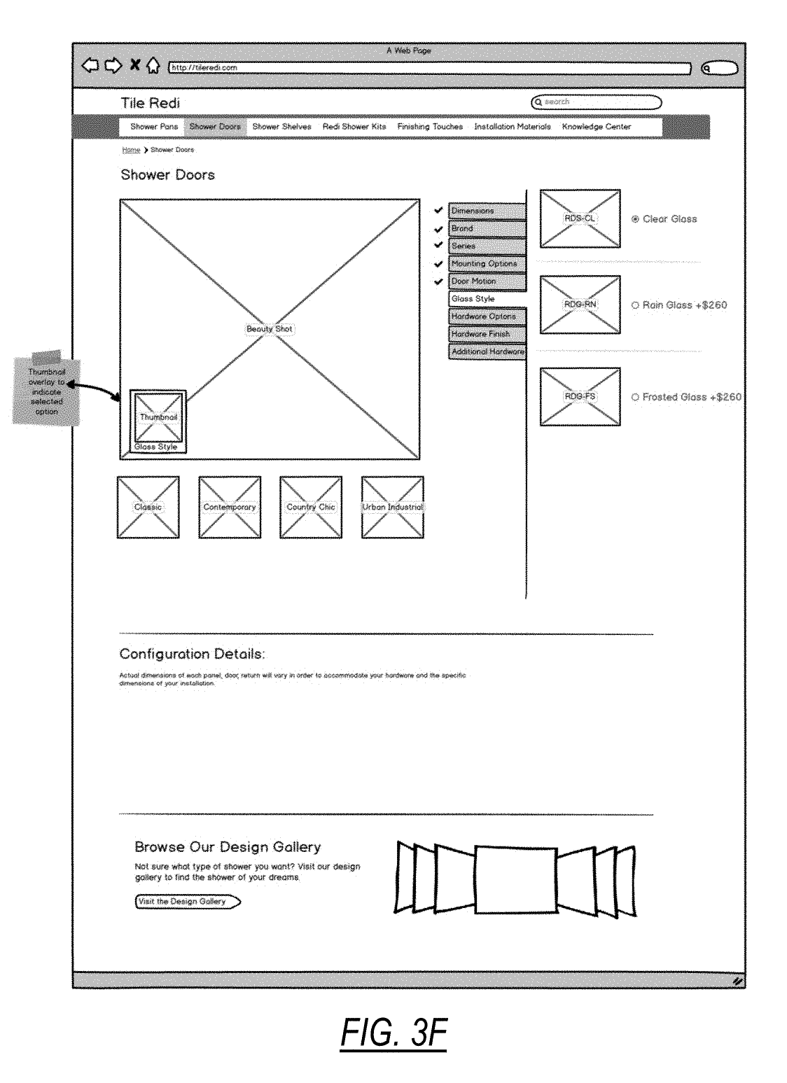

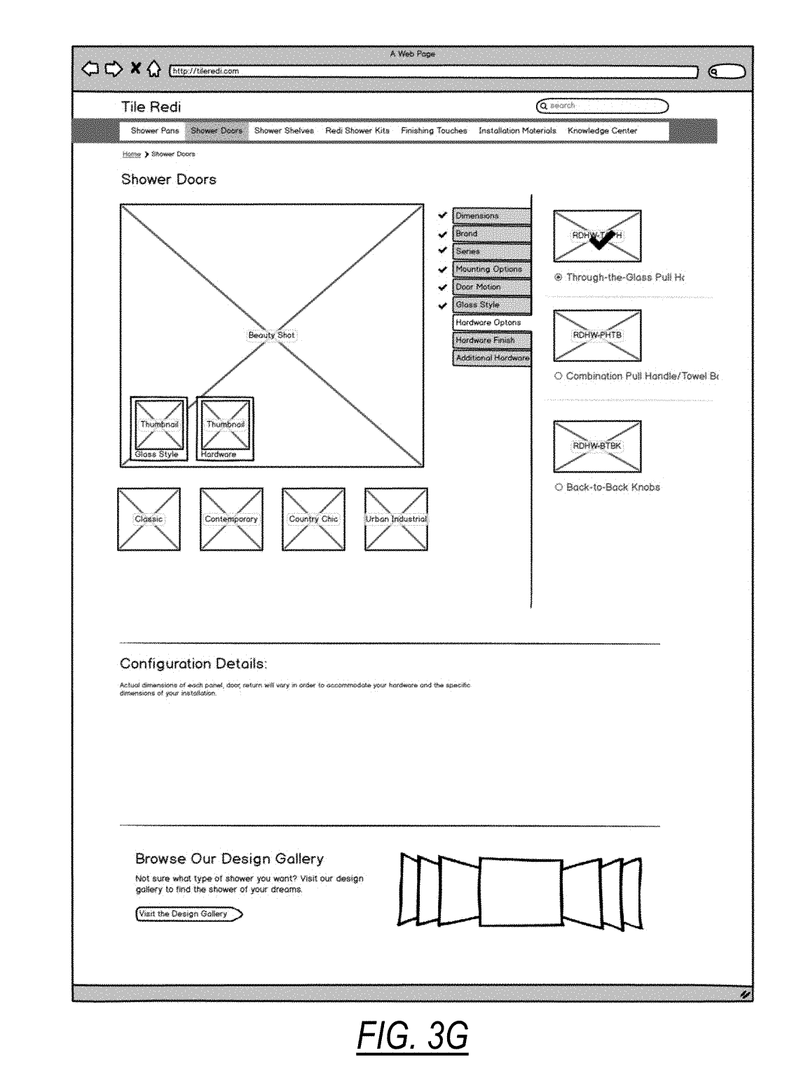

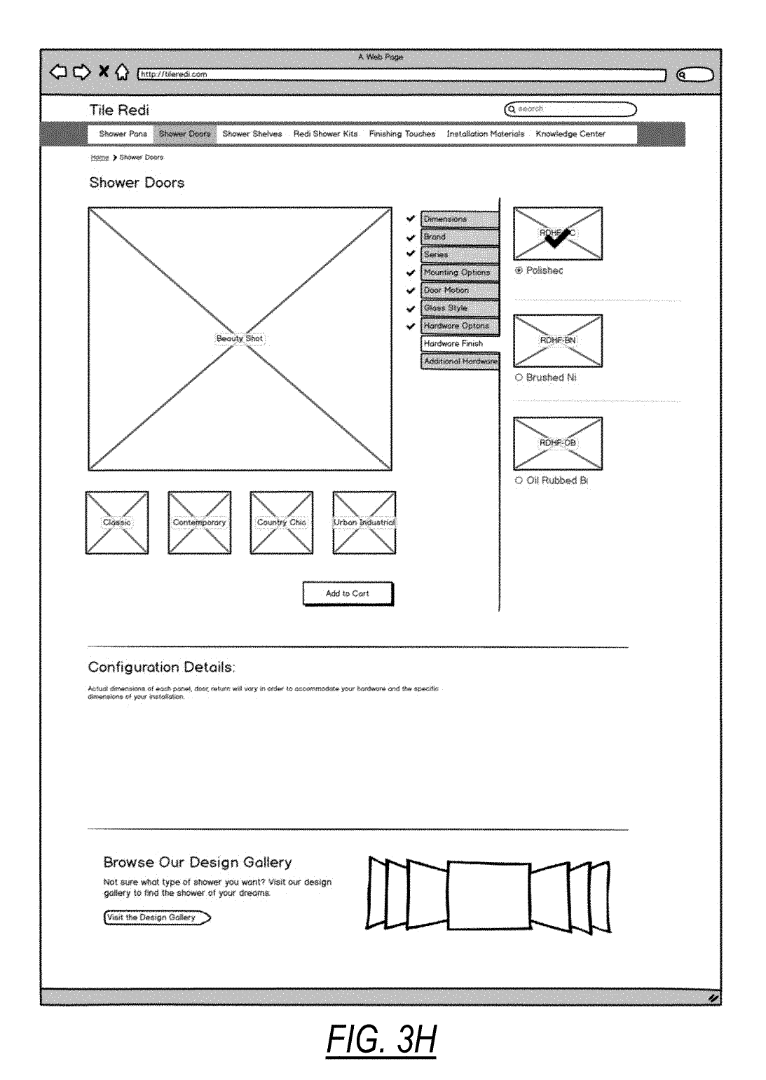

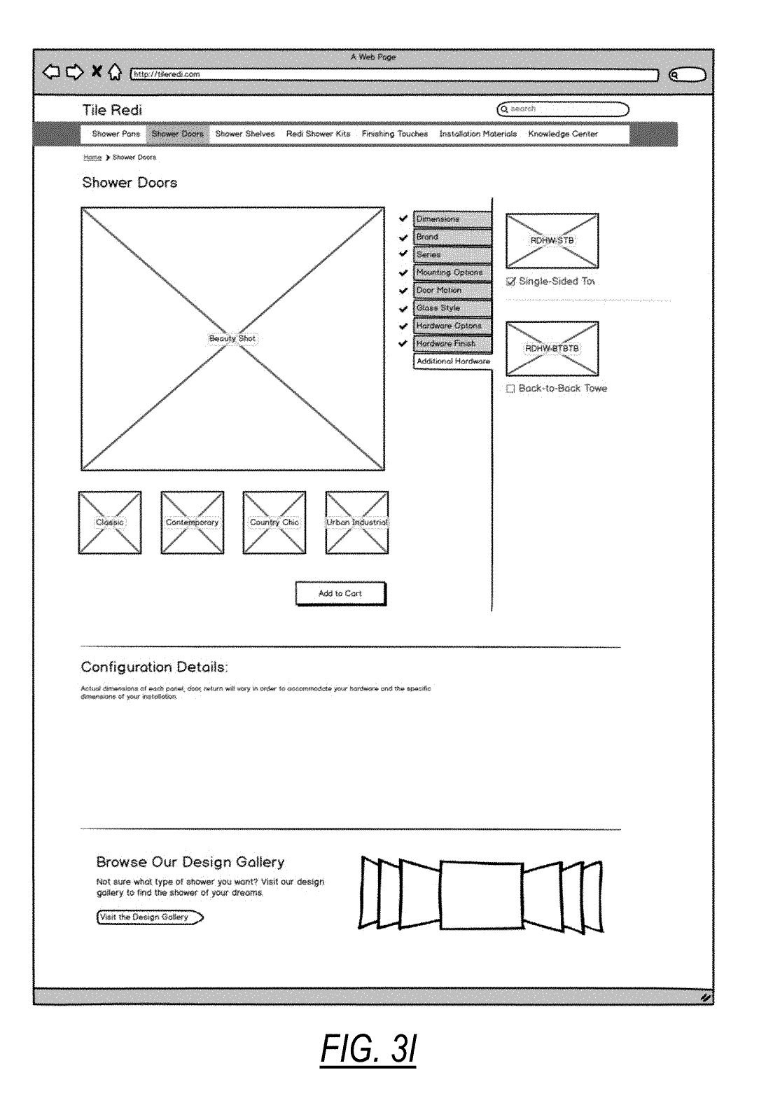

FIGS. 3A-3I are wireframes of representative web pages depicting an operation and flow of at least one embodiment of the inventive system and method suitable for use in allowing a customer to design the look and configuration of a bathroom shower.

FIG. 3A illustrates a screen display, e.g., a web page, through which a prospective customer can select components of a bathroom product, e.g., shower, to design, showing the available shower pan configurations for the user to select from. The user is presented the option to select a theme or “décor” for the environment or room that the shower to be built will be depicted in. That environment or room may be displayed in first visual representation area 100. Alternative environments may be offered as choices. The environment may be the architectural configuration of a portion or all of a bathroom depicted in photo-realistic graphics, or any other media for depicting the environment in which the shower will be depicted for a consumer to see. The buttons 102a-102m represent décor visual representation areas, each of which depicts a different décor, such as “classic,” contemporary,” “country chic,” “modern,” “urban industrial” and/or any other décor in which the background or environment may be depicted. Selecting any one of these buttons will result in the environment in which the shower will be depicted for the customer to see in first visual representation area 100 being converted to the stated décor, e.g., “classic,” contemporary,” “country chic,” urban industrial” or any other limitless styles, themes or décor.

In some embodiments, the first visual representation area 100 incorporates one or more blank spaces where the product, or features, parts or accessories thereof or therefore, can be incorporated into the image in response to the user's selections and the system(s) and methods of the invention.

As with many of the embodiments disclosed herein, a customizable library system is employed, permitting the user to customize the presentation to change the sequencing of the products or experience, enlarge or shrink/reduce the number of products to be displayed, all to suite a particular user or circumstance. A user can instantly change between theme and/or decors at the beginning of the selection process, or, optionally, at any time during the selection/design process, by clicking or otherwise selecting an option to change decors.

Second visual representation areas 202-209 may be used to provide buttons/links to specific shower components and/or features, such as shower dimensions, pan model, product series, mounting options, direction of door motion (i.e., left swing, right swing), glass style, hardware options, hardware finish, additional shower or bathroom hardware, and the like. In an embodiment, selecting the “dimensions” button will cause a drop-down menu or other selection list 216 to display available dimensions for the shower to be displayed. From such selection list 216, the user selects the dimensions of the shower being designed. In an embodiment, upon selection of shower dimensions, the graphical representation of the architecture of the bathroom shown in first visual representation area 100 will be changed in real time so that the depicted shower area matches or otherwise becomes compatible with the basic shape of the shower selected by the user.

In some embodiments, the second visual representation areas 202-209 incorporate one or more blank spaces in some or all of the displayed available optional criteria, i.e., features, parts or accessories, where other optional criteria, i.e., features, parts or accessories, can be incorporated into the selected or pre-existing optional criteria. The system combines the features, parts or accessories selected by the user with the chosen optional criteria in such a way that the user builds the optional criteria part-by-part, accessory-by-accessory and feature-by-feature by filling in or populating the blank spaces in the optional criteria with additional features, parts or accessories, including sub-features, parts or accessories, for eventual incorporation into the product being designed, selected and/or purchased.

FIGS. 3B-3I show changes to the wireframes in this embodiment as the user progresses through a selection/design process. With respect to each product category being illustrated, the user can select an inventoried product or a custom product, or a combination of both. A plurality of customization options are made available from which to select (and customize if that feature is offered). The first visual representation area is then updated each time a selection is made using buttons 201-209. Upon customization of the first design options, the configuration details (i.e., the selected individual components and features such as those associated with buttons 201-209) are updated based on the user selections. The configuration details are compared against a database of available products, the database presents available SKU's corresponding to the selected features, and eliminates configuration details that are incompatible with the combination of configuration details chosen by the user up to that point. As with many of the embodiments disclosed herein, a customizable library system is employed, permitting the user to customize the presentation to change the sequencing of the products or experience, enlarge or shrink/reduce the number of products to be displayed, all to suite a particular user or circumstance. FIG. 3B illustrates the continued customization of the selected product, showing, for this embodiment, the design criteria based on the pan model. Based on the dimension chosen using the illustration of FIG. 3A, the first visual representation area presents the user with the available pan models that match a SKU based on the dimension selections chosen by the user. The user selects the pan model from within the separate graphical panel and the graphical panel 301 is updated by a base image for the selected pan. The updated configuration details are updated and then again compared against a database of available products. The database presents an updated list of available SKU's and design criteria to limit selection criteria of other customizable features.

FIGS. 3C-3I present further choices of the remaining configurations for the user to customize. For each customization, the graphical panel 302 is updated by the over layering of images over the base image, or otherwise combining the first image with other images, to provide a representation of the product being designed/created while in-progress or the finished product. In certain embodiments, at each customization step, the configuration information is compared to the database to determine available SKU's and limits the selection criteria to the latter design configurations based on the previous selection and available SKU's. Between each selection the available configurations shown in the 303 separate graphical panel are updated.

The disclosure of specific implementations of the inventions described herein is not intending to be limiting to the scope of the inventions. For example, the inventions have application to the design, selection and purchase of products for use in any background or environment, such as any other indoor setting as well as outdoor settings.

Custom Interfaces for Third Parties

The systems and methods of this invention may be implemented to market the products of third parties either separately or in conjunction with a third person's products. In one implementation thereof, a custom interface is established using the look, feel and/or branding of the third party. All or a portion of the products offered by the third party may be made available at the option of the third party. The process of displaying products being constructed, and components and/or accessories to be added, using one or more visual representation areas, is employed as described in this disclosure.

Exemplary Software Implementation

The present invention further includes novel elements for the handling and processing of user requests in the dynamic design of custom products. In at least one embodiment, a user selects at least one product to design, and said selection is stored in memory. A database of the products to design, optional criteria associated therewith, and design selections associated therewith, which are accessible to the custom software, are accessed, and the optional criteria and design selection, along with the specifications and images for modifying a base image, are accessed and stored in memory.

In at least one embodiment, the optional criteria is presented from memory in a column or frame for user selection of an optional criteria to customize. Upon selection of a first optional criteria, the remaining optional criteria and associated design selections are filtered based on available combinations with the selected first optional criteria selected. The available remaining optional criteria and design selections are then stored in a second memory location. It is to be appreciated that the first optional criteria remains modifiable, even after it is selected, based on the information stored in the first memory location. Thus, in the event that the first optional criteria is altered, the available remaining optional criteria and design selections based on the now altered first optional criteria are then stored in a second memory location.

In at least one embodiment, a plurality of memory locations exist which store refined data based on the previous selection(s) of optional criteria and/or design selections until a product is selected. Without being bound to a particular methodology, it is believed that providing the plurality of memory locations for storing of refined selectable optional criteria and design selections (along with associated specifications, SKU's and base image modifications therewith) allows for seamless transitions and 3D representation of the product under design as an optional criteria or a design selection is modified, ultimately until a single SKU remains available based on the previous selections of optional criteria and design selections associated therewith.

It should also be appreciated that, while modifying the base images to incorporate the optional criteria and design selections, such modifications alter the graphical representation of the product under design, while the image remains a composite of the base image along with all of the base image modifications incorporated into the base image based on the selection of the optional criteria and design selections associated therewith. This unique feature allows for the rapid transmission of graphical data while being able to design and configure an entire catalog of products, without having to store and transmit full images of each conceivable product, thus allowing for a true representation of a product under design in real-time without altering the view or location of the other selected optional criteria and design selections associated therewith.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

Although this disclosure has been described in terms of certain embodiments and generally associated methods, alterations and permutations of these embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A system for dynamically designing products that are comprised of multiple components, the system comprising:
a computing device running custom software for designing products that are comprised of multiple components, the custom software for interacting with a database containing information related to available products, base images for available products, selectable or modifiable optional criteria and subcomponents for available products, and design selections for the modifiable optional criteria and subcomponents, wherein the custom software provides a base image representing the base architecture of an available product, modifies the base image by overlaying images of one or more selected components atop the base image of the available product, and eliminates any remaining selectable components that are incompatible with the components that have already been selected.

2. The system of claim 1 further comprising:
a communication network having at least one of a cellular data network and a Wi-Fi network, wherein said computing device and said custom software are in communication with a server using the communication network; and
a server for interfacing with the custom software, said server containing said database containing information related to available products, base images for the available products, selectable or modifiable optional criteria and subcomponents for the available products, and selections for the modifiable optional criteria and subcomponents.

3. A method for dynamically designing products that are comprised of multiple components, the method comprising:
initiating custom software for designing products that are comprised of multiple components installed on a computing device or accessed through a web application;
providing an option for the selection of at least one product to design;
receiving a selection from a user of at least one product to design, said product having at least one optional criteria associated therewith;
receiving a selection, from a database of base images, of at least one base image for the selected product and providing a visual representation thereof, said base image representing a basic architecture in which the selected product can be used;
loading from the database and providing a selection of one or more optional criteria based on the product selected for a user to select, said optional criteria having at least one design selection;
selecting a first optional criteria;
loading from the database and providing a selection of available design selections for the first optional criteria;
selecting a design selection for the first optional component;
modifying the base image by adding the design selection of the first optional component to the base image;
limiting the remaining available design selections for the additional optional criteria based on the selection of the first optional criteria;
selecting design selections for the additional optional criteria; and
modifying the base image by adding the design selection/additional optional component to the base image based on the selection of the design selection/additional optional criteria.

4. The method of claim 3, further comprising:
one or more blank space in the depicted base image; and
adding the first selected optional component to one of the at least one blank spaces.

5. The method of claim 3 wherein said database contains information related to available products, base images for available products, optional criteria for available products, and design selections for the optional criteria for available products.

6. The method of claim 3 wherein said at least one optional criteria is to specify for the product the dimension of the product, size of the product, brand of product, style of product, selection and position of subcomponents, style of subcomponents, brand or subcomponent, mounting options of the product, hardware options of the product or subcomponent, hardware finish of the product or subcomponent, or combinations thereof.

7. The method of claim 3 further comprising:
optionally providing one or more additional products to design;
selecting at least one additional product;
pre-populating information for certain optional criteria based on the design of the first product; and
limiting the remaining available optional criteria and design selections for the optional criteria based on the pre-populated information for certain optional criteria.

8. The method of claim 3 further comprising optionally providing a cost estimate based on the designed product.

9. The method of claim 3 further comprising purchasing the designed product.

10. The method of claim 3, wherein the steps of initiating custom software, providing an option for the selection of at least one product to design and modifying the base image by adding the design selection of the first optional component to the base image are carried out on a single web page.

11. The method of claim 3, wherein:
the step of modifying the base image by adding the design selection of the first optional component is carried out by either over layering of additional component image layers, superimposing of additional component images, addition of component images, or creation of new images.

12. The method of claim 3, further comprising carrying out the method on a private labeled graphical user interface.

13. The method of claim 3, wherein the option for the selection of at least one product to design, the database of base images, and the database of optional components, can be varied to permit third parties to customize the experience made available to their customers.

14. The method of claim 3, further including a provision that enables a user to create custom products.

15. The method of claim 3, wherein the products are bathrooms.

16. The method of claim 3, wherein the products are showers.

17. The method of claim 3, wherein the products are kitchens.

18. The method of claim 3, wherein the products are indoor rooms.

19. The method of claim 3, wherein the products are outdoor rooms.

20. A non-transitory computer-readable medium containing computer-readably instructions which, when executed, cause a computer to perform a method for dynamically designing a shower or bathroom, the method comprising:
providing an option for the selection of at least product to design t;
selecting at least one product to design, said product having at least one optional criteria;
selecting from a database of product images of at least one base image of the selected product and providing a visual representation thereof, said base image representing the basic architecture of the selected product;
loading from the database and providing a selection of one or more pre-specified optional criteria based on the product selected for a user to select, said optional criteria having at least one design selection;
selecting a first optional criteria;
loading from the database and providing a selection of available design selections for the first optional component;
selecting a design selection for the first optional component;
modifying the base image by overlaying a portion of the base image with a base image of the design selection of the first optional component based on the selection of the design selection first optional criteria;
limiting the remaining available design selections for the additional optional criteria based on the design selection of the selected first optional criteria;
selecting the design selections for the additional optional criteria; and
modifying the base image by adding the design selection of the additional optional component to the base image based on the selection of the design selection additional optional criteria.

21. The method of claim 20 wherein said database contains information related to available components for products, base images for available products, optional criteria for available products, and design selections for the optional criteria for available products.

22. The method of claim 21 wherein said product is selected from the group consisting of: one or more shower pans, one or more shower doors, one or more niches, one or more drains, one or more curbs, one or more benches, one or more niches, one or more glass panels, shower hardware, shower fixtures and accessories, one or more wall covering, floor covering, and one or more bathroom accessories

23. The method of claim 21, wherein said at least one optional criteria is to specify for the product the dimension of product, size of the product, brand of product, style of product, selection and position of subcomponents, style of subcomponents, brand or subcomponent, mounting options of the product, hardware options of the product or subcomponent, hardware finish of the product or subcomponent, wall coverings, floor coverings, bathroom accessories, or combinations thereof.

24. The method of claim 21 further comprising:
optionally providing one or more additional products to design;
selecting at least one additional products;
pre-populating information for certain optional criteria based on the design of the first product; and
limiting the remaining available optional criteria and design selections for the optional criteria based on the pre-populated information for certain optional criteria.

25. The method of claim 21 further comprising optionally providing a cost estimate based on the designed product.

26. The method of claim 11 further comprising purchasing the designed product.

27. The method of claim 11, wherein the steps of initiating custom software, providing an option for the selection of at least one product to design and modifying the base image by adding the design selection of the first optional component to the base image are carried out on a single web page.

28. The method of claim 21, wherein:
the step of modifying the base image by adding the design selection of the first optional component is carried out by either over layering of additional component image layers, superimposing of additional component images, addition of component images, or creation of new images.

29. The method of claim 21, further comprising carrying out the method on a private labeled graphical user interface.

30. The method of claim 21, wherein the option for the selection of at least one product to design, the database of base images, and the database of optional components, can be varied to permit third parties to customize the experience made available to their customers.

31. The method of claim 21, further including a provision that enables a user to create custom products.

32. The method of claim 21, wherein the products are bathrooms.

33. The method of claim 21, wherein the products are showers.

34. The method of claim 21, wherein the products are kitchens.

35. The method of claim 21, wherein the products are indoor rooms.

36. The method of claim 21, wherein the products are outdoor rooms.

37. A method for dynamically designing products that are comprised of multiple components, the method comprising:
initiating custom software for designing products that are comprised of multiple components installed on a computing device or accessed through a web application;
providing an option for the selection of at least product to design;
selecting at least one product to design, said product having at least one optional criteria;
selecting from a database of product images of at least one base image of the selected product and providing a first visual representation thereof, said base image representing the basic architecture of the selected product;
loading from the database and providing a selection of two or more pre-specified optional criteria based on the product selected, said optional criteria having at least one design selection;
selecting a first optional criteria from a second visual representation thereof, said second visual representation displaying the basic architecture of the first optional criteria;
loading from the database and providing a selection of available design selections for the first optional component;
modifying the second visual representation by displaying the basic architecture of the available design selections;
selecting a design selection for the first optional component from the second visual representation;
modifying the base image by overlaying a portion of the base image with a base image of the design selection of the first optional component based on the selection of the design selection first optional criteria;
limiting the remaining available design selections for the additional optional criteria based on the design selection of the selected first optional criteria;
selecting the design selections for the additional optional criteria from the second visual representation; and
modifying the base image by overlaying a portion of the base image with a base image of the design selection of the additional optional component based on the selection of the design selection additional optional criteria.

38. The method of claim 37 wherein said first visual representation is a three-dimensional graphical display.

39. The method of claim 38 wherein said second visual representation is either a two-dimensional line-art display or a three dimensional graphical display.

40. The method of claim 38, wherein the steps of initiating custom software, providing an option for the selection of at least one product to design and modifying the base image by adding the design selection of the first optional component to the base image are carried out on a single web page.

41. The method of claim 38, wherein:
the step of modifying the base image by adding the design selection of the first optional component is carried out by either over layering of additional component image layers, superimposing of additional component images, addition of component images, or creation of new images.

42. The method of claim 38, further comprising carrying out the method on a private labeled graphical user interface.

43. The method of claim 38, wherein the option for the selection of at least one product to design, the database of base images, and the database of optional components, can be varied to permit third parties to customize the experience made available to their customers.

44. The method of claim 38, further including a provision that enables a user to create custom products.

45. The method of claim 38, wherein the products are bathrooms.

46. The method of claim 38, wherein the products are showers.

47. The method of claim 38, wherein the products are kitchens.

48. The method of claim 38, wherein the products are indoor rooms.

49. The method of claim 38, wherein the products are outdoor rooms.

50. A system for dynamically selecting products that are comprised of multiple components, the system comprising:
a computing device running custom software for designing products that are comprised of multiple components, the custom software for interacting with a database containing information related to available products, base images for available products, selectable or modifiable optional criteria and subcomponents for available products, and design selections for the modifiable optional criteria and subcomponents, wherein the custom software provides a base image representing the base architecture of an available product, modifies the base image by overlaying images of one or more selected components atop the base image of the available product, and eliminates any remaining selectable components that are incompatible with the components that have already been selected.

51. The system of claim 50 further comprising:
a communication network having at least one of a cellular data network and a Wi-Fi network, wherein said computing device and said custom software are in communication with a server using the communication network; and
a server for interfacing with the custom software, said server containing said database containing information related to available products, base images for the available products, selectable or modifiable optional criteria and subcomponents for the available products, and design selections for the modifiable optional criteria and subcomponents.

52. A method for dynamically selecting products that are comprised of multiple components, the method comprising:
initiating custom software for selecting products that are comprised of multiple components installed on a computing device or accessed through a web application;
accessing an option for the selection of at least one product to design;
selecting at least one product to purchase, said product having at least one optional criteria;
selecting from a database of product images at least one base image of the selected product and accessing a visual representation thereof, said base image representing the basic architecture of the selected product;
receiving from the database a selection of one or more pre-specified optional criteria based on the product selected, said optional criteria having at least one design selection;
selecting a first optional criteria;
accessing from the database a selection of available design selections for the first optional component;
selecting a design selection for the first optional component;
causing the base image to be modified by adding the design selection of the first optional component to the base image;
limiting the remaining available design selections for the additional optional criteria based on the design selection of the selected first optional criteria;
selecting the design selections for the additional optional criteria; and
causing the base image to be modified by adding the design selection of the additional optional component to the base image based on the selection of the design selection additional optional criteria.

53. The method of claim 52 wherein said database contains information related to available products, base images for available products, optional criteria for available products, and design selections for the optional criteria for available products.

54. The method of claim 52 wherein said at least one optional criteria is to specify for the product the dimension of the product, size of the product, brand of product, style of product, selection and position of subcomponents, style of subcomponents, brand or subcomponent, mounting options of the product, hardware options of the product or subcomponent, hardware finish of the product or subcomponent, or combinations thereof.

55. The method of claim 52, wherein the steps of initiating custom software, providing an option for the selection of at least one product to design and modifying the base image by adding the design selection of the first optional component to the base image are carried out on a single web page.

56. The method of claim 52, wherein:
the step of modifying the base image by adding the design selection of the first optional component is carried out by either over layering of additional component image layers, superimposing of additional component images, addition of component images, or creation of new images.

57. The method of claim 52, further comprising carrying out the method on a private labeled graphical user interface.

58. The method of claim 52, wherein the option for the selection of at least one product to design, the database of base images, and the database of optional components, can be varied to permit third parties to customize the experience made available to their customers.

59. The method of claim 52, further including a provision that enables a user to create custom products.

60. The method of claim 52, wherein the products are bathrooms.

61. The method of claim 52, wherein the products are showers.

62. The method of claim 52, wherein the products are kitchens.

63. The method of claim 52, wherein the products are indoor rooms.

64. The method of claim 52, wherein the products are outdoor rooms.

65. The method of claim 52, wherein the steps of initiating custom software, providing an option for the selection of at least one product to design and modifying the base image by adding the design selection of the first optional component to the base image are carried out on two or more web pages.

66. The method of claim 52, further comprising:
optionally providing one or more additional products to design;
selecting at least one additional product;
pre-populating information for certain optional criteria based on the design of the first product; and
limiting the remaining available optional criteria and design selections for the optional criteria based on the pre-populated information for certain optional criteria.

67. The method of claim 52 further comprising optionally accessing a cost estimate based on the designed product.

68. The method of claim 52 further comprising purchasing the designed product.

69. A non-transitory computer-readable medium containing computer-readably instructions which, when executed, cause a computer to perform a method for dynamically designing a shower or bathroom, the method comprising:
accessing an option to select at least one product to design;
selecting at least one product to design, said product having at least one optional criteria;
selecting from a database of product images of at least one base image of the selected product and providing a visual representation thereof, said base image representing the basic architecture of the selected product;
accessing from the database a selection of two or more pre-specified optional criteria based on the product selected, said optional criteria having at least one design selection;
selecting a first optional criteria;
accessing from the database a selection of available design selections for the first optional component;
selecting a design selection for the first optional component;
causing the base image to be modified by adding the design selection of the first optional component to the base image;
accessing remaining available design selections for the additional optional criteria based on the design selection of the selected first optional criteria;
selecting the design selections for the additional optional criteria; and
modifying the base image by adding the design selection of the additional optional component to the base image based on the selection of the design selection additional optional criteria.

70. The method of claim 69, wherein said database contains information related to available components for products, base images for available products, optional criteria for available products, and design selections for the optional criteria for available products.

71. The method of claim 70, wherein said product is selected from the group consisting of: one or more shower pans, one or more shower doors, one or more niches, one or more drains, one or more curbs, one or more benches, one or more niches, one or more glass panels, shower hardware, bathroom hardware, shower fixtures and accessories, one or more wall coverings, one or more floor coverings, one or more plumbing fixtures, one or more other shower products, one or more other bathroom products.

72. The method of claim 70, wherein said at least one optional criteria is to specify for the product the dimension of product, size of the product, brand of product, style of product, selection and position of subcomponents, style of subcomponents, brand or subcomponent, mounting options of the product, hardware options of the product or subcomponent, hardware finish of the product or subcomponent, or combinations thereof.

73. The method of claim 70, further comprising:
optionally accessing one or more additional products to design;
selecting at least one additional products;
accessing information for certain optional criteria based on the design of the first product; and
accessing remaining available optional criteria and design selections for the optional criteria based on the pre-populated information for certain optional criteria.

74. The method of claim 70, further comprising optionally accessing a cost estimate based on the designed product.

75. The method of claim 70, further comprising purchasing the one or more of the designed products.

76. The method of claim 70, wherein the steps of initiating custom software, providing an option for the selection of at least one product to design and modifying the base image by adding the design selection of the first optional component to the base image are carried out on a single web page.

77. The method of claim 70, wherein:
the step of modifying the base image by adding the design selection of the first optional component is carried out by either over layering of additional component image layers, superimposing of additional component images, addition of component images, or creation of new images.

78. The method of claim 70, further comprising carrying out the method on a private labeled graphical user interface.

79. The method of claim 70, wherein the option for the selection of at least one product to design, the database of base images, and the database of optional components, can be varied to permit third parties to customize the experience made available to their customers.

80. The method of claim 70, further including a provision that enables a user to create custom products.

81. The method of claim 70, wherein the products are bathrooms.

82. The method of claim 70, wherein the products are showers.

83. The method of claim 70, wherein the products are kitchens.

84. The method of claim 70, wherein the products are indoor rooms.

85. The method of claim 70, wherein the products are outdoor rooms.

86. The method of claim 70, wherein the steps of initiating custom software, providing an option for the selection of at least one product to design and modifying the base image by adding the design selection of the first optional component to the base image are carried out on two or more web pages.

87. A method for dynamically designing products that are comprised of multiple components, the method comprising:
accessing custom software for selecting products that is comprised of multiple components installed on a computing device or accessed through a web application;
accessing an option for the choosing at least one product to select;
selecting at least one product to design, said product having at least one optional criteria;
selecting from a database of product images of at least one base image of the selected product and providing a first visual representation thereof, said base image representing the basic architecture of the selected product;
loading from the database and selecting two or more pre-specified optional criteria based on the product selected, said optional criteria having at least one design selection;
selecting a first optional criteria from a second visual representation thereof, said second visual representation displaying the basic architecture of the first optional criteria;
accessing from the database a selection of available design selections for the first optional component;
causing the second visual representation to be modified by having the basic architecture of the available design selections be displayed;
selecting a design selection for the first optional component from the second visual representation;
causing the base image to be modified by adding the design selection of the first optional component to at least a portion of the base image;
accessing the remaining available design selections for the additional optional criteria based on the design selection of the selected first optional criteria;
selecting the design selections for the additional optional criteria from the second visual representation; and
causing the base image by to be modified by adding the design selection of the additional optional component to at least a portion of the base image.

88. The method of claim 87 wherein said first visual representation is a three-dimensional graphical display.

89. The method of claim 87 wherein said second visual representation is a two-dimensional line-art display and/or a three dimensional graphical display

90. A system for dynamically purchasing products that are comprised of multiple components, the system comprising:
a computing device running custom software for purchasing products that are comprised of multiple components, the custom software for interacting with a database containing information related to available products, base images for available products, selectable or modifiable optional criteria and subcomponents for available products, and design selections for the modifiable optional criteria and subcomponents, wherein the custom software provides a base image representing the base architecture of an available product, modifies the base image by over layering of additional component image layers, superimposing of additional component images, addition of component images, and/or creation of new images and eliminates any remaining selectable components that are incompatible with the components that have already been selected.

91. The system of claim 90, further comprising:
a communication network having at least one of a cellular data network and a Wi-Fi network, wherein said computing device and said custom software are in communication with a server using the communication network; and
a server for interfacing with the custom software, said server containing said database containing information related to available products, base images for the available products, selectable or modifiable optional criteria and subcomponents for the available products, and design selections for the modifiable optional criteria and subcomponents.

92. A method for dynamically purchasing products that are comprised of multiple components, the method comprising:
initiating custom software for purchasing products that are comprised of multiple components installed on a computing device or accessed through a web application;
providing an option for the selection of at least one product to design;
selecting at least one product to design, said product having at least one optional criteria;
selecting from a database of product images at least one base image of the selected product and providing a visual representation thereof, said base image representing the basic architecture of the selected product;
loading from the database and providing a selection of one or more pre-specified optional criteria based on the product selected for a user to select, said optional criteria having at least one design selection;
selecting a first optional criteria;
loading from the database and providing a selection of available design selections for the first optional component;
selecting a design selection for the first optional component;
modifying the base image by adding the design selection of the first optional component to the base image;
limiting the remaining available design selections for the additional optional criteria based on the design selection of the selected first optional criteria;
selecting the design selections for the additional optional criteria; and
modifying the base image by adding the design selection of the additional optional component to the base image based on the selection of the design selection additional optional criteria.

93. The method of claim 92 wherein said database contains information related to available products, base images for available products, optional criteria for available products, and design selections for the optional criteria for available products.

94. The method of claim 92 wherein said at least one optional criteria is to specify for the product the dimension of the product, size of the product, brand of product, style of product, selection and position of subcomponents, style of subcomponents, brand or subcomponent, mounting options of the product, hardware options of the product or subcomponent, hardware finish of the product or subcomponent, or combinations thereof.

95. The method of claim 92 further comprising:
optionally providing one or more additional products to purchase;
purchasing at least one additional product;
pre-populating information for certain optional criteria based on the design of the first product; and
limiting the remaining available optional criteria and design selections for the optional criteria based on the pre-populated information for certain optional criteria.

96. The method of claim 92 further comprising optionally providing a cost estimate based on the designed product.

97. The method of claim 92, wherein the steps of initiating custom software, providing an option for the selection of at least one product to design and modifying the base image by adding the design selection of the first optional component to the base image are carried out on a single web page.

98. The method of claim 92, wherein:
the step of modifying the base image by adding the design selection of the first optional component is carried out by either over layering of additional component image layers, superimposing of additional component images, addition of component images, or creation of new images.

99. The method of claim 92, further comprising carrying out the method on a private labeled graphical user interface.

100. The method of claim 92, wherein the option for the selection of at least one product to design, the database of base images, and the database of optional components, can be varied to permit third parties to customize the experience made available to their customers.

101. The method of claim 92, further including a provision that enables a user to create custom products.

102. The method of claim 92, wherein the products are bathrooms.

103. The method of claim 92, wherein the products are showers.

104. The method of claim 92, wherein the products are kitchens.

105. The method of claim 92, wherein the products are indoor rooms.

106. The method of claim 92, wherein the products are outdoor rooms.

107. The method of claim 92, wherein the steps of initiating custom software, providing an option for the selection of at least one product to design and modifying the base image by adding the design selection of the first optional component to the base image are carried out on two or more web pages.

108. A non-transitory computer-readable medium containing computer-readably instructions which, when executed, cause a computer to perform a method for dynamically purchasing a shower or bathroom, the method comprising:
providing an option for the selection of at least a product to design;
selecting at least one product to purchase, said product having at least one optional criteria;
selecting from a database of product images of at least one base image of the selected product and providing a visual representation thereof, said base image representing the basic architecture of the selected product;
loading from the database and providing a selection of two or more pre-specified optional criteria based on the product selected for a user to select, said optional criteria having at least one design selection;
selecting a first optional criteria;
loading from the database and providing a selection of available design selections for the first optional component;
selecting a design selection for the first optional component;
modifying the base image by overlaying a portion of the base image with a base image of the design selection of the first optional component based on the selection of the design selection first optional criteria;
limiting the remaining available design selections for the additional optional criteria based on the design selection of the selected first optional criteria;
selecting the design selections for the additional optional criteria; and
modifying the base image by adding the design selection of the additional optional component to the base image based on the selection of the design selection additional optional criteria.

109. The method of claim 108 wherein said database contains information related to available components for products, base images for available products, optional criteria for available products, and design selections for the optional criteria for available products.

110. The method of claim 108 wherein said product is selected from the group consisting of: one or more shower pans, one or more shower doors, one or more niches, one or more drains, one or more curbs, one or more benches, one or more niches, one or more glass panels, shower hardware, shower fixtures and accessories.

111. The method of claim 108, wherein said at least one optional criteria is to specify for the product the dimension of product, size of the product, brand of product, style of product, selection and position of subcomponents, style of subcomponents, brand or subcomponent, mounting options of the product, hardware options of the product or subcomponent, hardware finish of the product or subcomponent, or combinations thereof.

112. The method of claim 108 further comprising:
optionally providing one or more additional products to purchase;
allowing a user to select at least one additional product;
pre-populating information for certain optional criteria based on the design of the first product; and
limiting the remaining available optional criteria and design selections for the optional criteria based on the pre-populated information for certain optional criteria.

113. The method of claim 108 further comprising optionally providing a cost estimate based on the designed product.

114. A method for dynamically shopping for products that are comprised of multiple components, the method comprising:
initiating custom software for purchasing products that are comprised of multiple components installed on a computing device or accessed through a web application;
providing an option for the selection of at least product to purchase;
selecting at least one product to purchase, said product having at least one optional criteria;
selecting from a database of product images of at least one base image of the selected product and providing a first visual representation thereof, said base image representing the basic architecture of the selected product;
loading from the database and providing a selection of two or more pre-specified optional criteria based on the product selected, said optional criteria having at least one design selection;
selecting a first optional criteria from a second visual representation thereof, said second visual representation displaying the basic architecture of the first optional criteria;
loading from the database and providing a selection of available design selections for the first optional component;
modifying the second visual representation by displaying the basic architecture of the available design selections;
selecting a design selection for the first optional component from the second visual representation;
modifying the base image by overlaying a portion of the base image with a base image of the design selection of the first optional component based on the selection of the design selection first optional criteria;
limiting the remaining available design selections for the additional optional criteria based on the design selection of the selected first optional criteria;
selecting the design selections for the additional optional criteria from the second visual representation; and
modifying the base image by adding the design selection of the additional optional component to a portion of the base image.

115. The method of claim 114 wherein said first visual representation is a three-dimensional graphical display.

116. The method of claim 114 wherein said second visual representation is the two-dimensional line-art display.

117. The method of claim 114, wherein the steps of initiating custom software, providing an option for the selection of at least one product to design and modifying the base image by adding the design selection of the first optional component to the base image are carried out on a single web page.

118. The method of claim 114, wherein:
the step of modifying the base image by adding the design selection of the first optional component is carried out by either over layering of additional component image layers, superimposing of additional component images, addition of component images, or creation of new images.

119. The method of claim 114, further comprising carrying out the method on a private labeled graphical user interface.

120. The method of claim 114 wherein the option for the selection of at least one product to design, the database of base images, and the database of optional components, can be varied to permit third parties to customize the experience made available to their customers.

121. The method of claim 114, further including a provision that enables a user to create custom products.

122. The method of claim 114, wherein the products are bathrooms.

123. The method of claim 114, wherein the products are showers.

124. The method of claim 114, wherein the products are kitchens.

125. The method of claim 114, wherein the products are indoor rooms.

126. The method of claim 114, wherein the products are outdoor rooms.

127. The method of claim 114, wherein the steps of initiating custom software, providing an option for the selection of at least one product to design and modifying the base image by adding the design selection of the first optional component to the base image are carried out on two or more web pages.
